(19) United States
(12) Patent Application Publication
(10) Pub. No.: US 2015/0363763 A1
(43) Pub. Date: Dec. 17, 2015

(54) Mobile Information Apparatus That Includes A Secure Element Storing Payment Information And Using A Cryptographic Technique For Implementing Mobile Payment

(71) Applicant: Flexiworld Technologies, Inc,, Vancouver, WA (US)

(72) Inventors: William Ho Chang, Vancouver, WA (US); Vinaynathan Viswanathan, Pune (IN)

(73) Assignee: Flexiworld Technologies, Inc,, Vancouver, WA (US)

(21) Appl. No.: 14/835,585

(22) Filed: Aug. 25, 2015

Related U.S. Application Data
(63) Continuation of application No. 14/833,961, filed on Aug. 24, 2015.
Application No. 14/833,961 is a continuation of application No. 14/089,622, filed on Nov. 25, 2013, now Pat. No. 9,116,723.
Application No. 14/089,622 is a continuation of application No. 12/891,594, filed on Sep. 27, 2010, now Pat. No. 8,595,717.
Application No. 12/891,594 is a continuation of application No. 10/823,513, filed on Apr. 12, 2004, now Pat. No. 7,805,720.
Application No. 12/891,594 is a continuation-in-part of application No. 10/734,481, filed on Dec. 12, 2003.
Application No. 10/734,481 is a continuation-in-part of application No. 14/828,349, filed on Aug. 17, 2015.
Application No. 14/828,349 is a continuation of application No. 13/710,306, filed on Dec. 10, 2012, now Pat. No. 9,110,622.
Application No. 13/710,306 is a continuation of application No. 12/903,048, filed on Oct. 12, 2010, now Pat. No. 8,332,521.
Application No. 12/903,048 is a continuation of application No. 10/016,223, filed on Nov. 1, 2001, now Pat. No. 7,941,541.
(60) Provisional application No. 60/462,080, filed on Apr. 11, 2003.
(60) Provisional application No. 60/433,196, filed on Dec. 12, 2002.
(60) Provisional application No. 60/245,101, filed on Nov. 1, 2000.

(51) Int. Cl. G06Q 20/32; G06Q 20/38; H04W 12/06; G06Q 20/40; G06F 12/14; H04L 29/06

(52) U.S. Cl. CPC G06Q 20/322; G06F 12/1408; H04L 63/0861; H04W 12/06; G06Q 20/40145; G06Q 20/382; G06Q 20/4012; G06F 2212/1052; G06Q 2220/00

(57) ABSTRACT

A mobile information apparatus that includes a secure element for making mobile payments associated with a credit card or bank card, via a near distance radio frequency wireless communication unit, is herein disclosed and enabled. At least part of payment information or a device identification number is stored in the secure element or protected memory of the mobile information apparatus. Data stored in the secure element or protected memory is implemented to be not accessible by the user, but is accessible by a memory controller included in the mobile information apparatus implementing a cryptographic algorithm. To authorize payment, the user enters authentication information that may include a password, or a pin code, or user biometrics; and subsequent to the authentication, the mobile information apparatus transmits encrypted data over a short range radio frequency communication link to a wireless output controller or reader for making payment and transaction processing.

### CROSS-REFERENCES TO RELATED APPLICATIONS

This application is a continuation of U.S. patent application Ser. No. 14/833,961, filed on Aug. 24, 2015, which is a continuation of U.S. patent application Ser. No. 14/089,622, filed on Nov. 25, 2013, now U.S. Pat. No. 9,116,723, which is a continuation of U.S. patent application Ser. No. 12/891,594, filed on Sep. 27, 2010, now U.S. Pat. No. 8,595,717, which is (1) a continuation of U.S. patent application Ser. No. 10/823,513, filed on Apr. 12, 2004, now U.S. Pat. No. 7,805,720, which claims the benefit of U.S. Provisional Patent Application Ser. No. 60/462,080, filed on Apr. 11, 2003; and (2) a continuation-in-part of U.S. patent application Ser. No. 10/734,481, filed on Dec. 12, 2003, which claims the benefit of U.S. Provisional Patent Application Ser. No. 60/433,196, filed on Dec. 12, 2002. The complete disclosures of the above patent applications are hereby incorporated by reference for all purposes.

Additionally, this application is a continuation-in-part of U.S. patent application Ser. No. 14/828,349 filed Aug. 17, 2015, which is a continuation of U.S. patent application Ser. No. 13/710,306 filed Dec. 10, 2012, now U.S. Pat. No. 9,110,622, which is a continuation of U.S. patent application Ser. No. 12/903,048 filed Oct. 12, 2010, now U.S. Pat. No. 8,332,521, which is a continuation of U.S. patent application Ser. No. 10/016,223 filed Nov. 1, 2001, now U.S. Pat. No. 7,941,541, which claims benefit of U.S. Provisional Patent Application Ser. No. 60/245,101 filed on Nov. 1, 2000. The complete disclosures of the above patent applications are hereby incorporated by reference for all purposes.

### TECHNICAL FIELD

This invention relates to a system and method for utilizing storage media such as flash memory for achieving autorun of an application executable or installer stored on the storage media.

### BACKGROUND AND SUMMARY OF THE INVENTION

As is known in the art, some applications such as software installers may be run automatically upon insertion of a CD-ROM disc into a CD-ROM drive, which may sometimes be called a dock or reader. In operation, this automatic running of an application is provided by an autorun feature that is stored on or incorporated into CD-ROM drive dock/reader. Executables or installers stored on the CD-ROM disc are executed by the host personal computer based upon activation by the autorun feature in the CD-ROM drive dock/reader. In this implementation, the autorun feature is incorporated into the hardware drive/dock/reader, which is separate from the storage media.

Universal Serial Bus (USB) technology is rapidly gaining preference as the interfacing technology of choice for peripherals on computing devices such as personal or laptop computers. Flash memories coupled with a USB interface has become a convenient and portable storage device that can replaces floppy disks and compact disks (CDs).

However, the popular and widely-adopted Universal Serial Bus technology does not include distinct autorun features in the docks/readers. As a consequence, conventional integrated circuit memory devices such as USB memory devices do not have autorun functionality.

Accordingly, the present invention provides autorun functionality to any IC memory device, such as any USB peripheral, that has a memory component interfaced to a computing device interface microcontroller. The present invention provides autorun of one or more executables or application installers from a memory component with an interface to a computing device without an intermediate hardware-based autorun feature. As an example, such interface could be a USB interface and such computing device could be a personal computer.

For example, each USB peripheral device internally contains a USB microcontroller that performs the functionality associated with identifying the device to a host computing device, such as a personal computer. In accordance with the present invention, autorun firmware is embedded into the USB microcontroller. The autorun firmware enables autorun of an installable or executable application stored on the memory component of the USB device. The firmware acts as bridge component translating all commands and interactions between a host PC and the memory component.

Additional description and implementations of the present invention will be apparent from the detailed description of the preferred embodiment thereof, which proceeds with reference to the accompanying drawings.

### BRIEF DESCRIPTIONS OF THE DRAWINGS

FIG. 1 illustrates an exemplary implementation of an autorun integrated circuit (IC) memory device according to the present invention.

FIG. 2 is a block diagram of a prior art arrangement in which a host personal computer includes an intermediate hardware dock that provides an autorun feature.

FIG. 3 is a flow diagram of an IC memory device autorun method.

FIGS. 4A and 4B illustrate autorun firmware according to the present invention be embedded into alternative USB device configurations

FIG. 5 is a block diagram of a USB peripheral having multiple functionalities.

FIG. 6 is a block diagram of a USB hub with autorun firmware and access to multiple distinct functionalities.

FIG. 7 is a schematic diagram of a person-operable physical slide switch.

FIG. 8 is a flow diagram of a software-implemented copy protection method.

### DETAILED DESCRIPTION OF PREFERRED EMBODIMENT

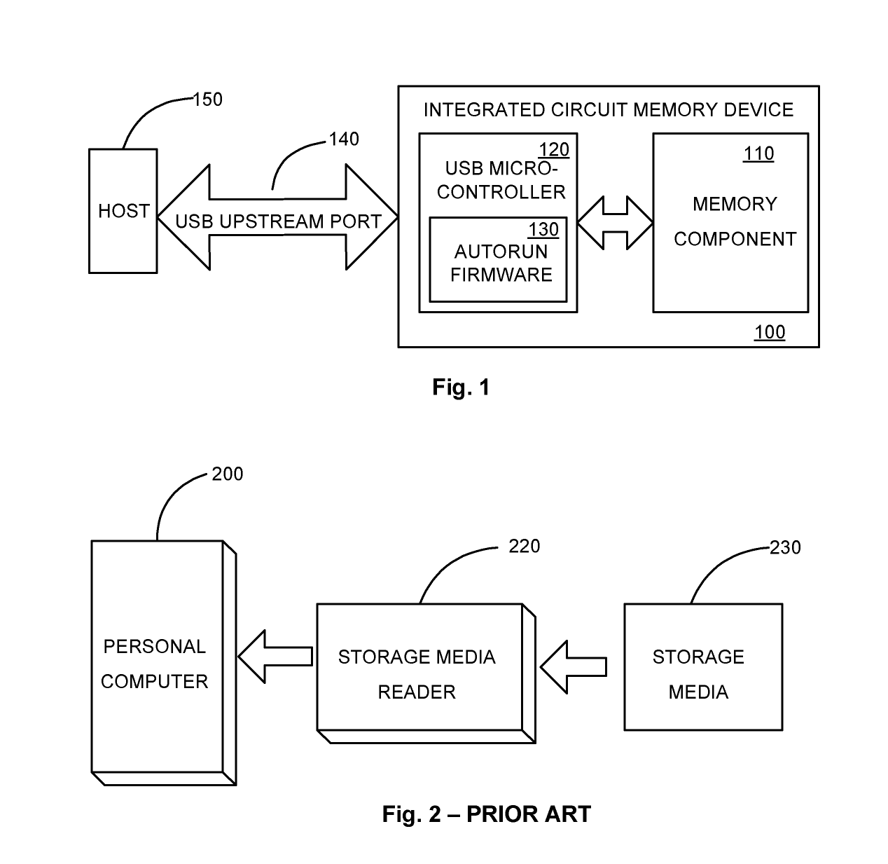

FIG. 1 illustrates an exemplary implementation of an autorun integrated circuit (IC) memory device 100 according to the present invention. Autorun IC memory device may be in the form of a USB memory device, a compact flash card, a smart card, etc. For purposes of illustration, autorun IC memory device 100 will be described with reference to a universal serial bus (USB) memory device implementation.

Autorun IC memory device 100 includes a memory component 110 that communicates with a USB microcontroller 120 having autorun firmware 130 incorporated or embedded into microcontroller 120. Autorun IC memory device 100 includes an upstream port 140 for connecting to a host computing device 150 (e.g., personal or laptop computer, handheld computer, PDA, smart phone, etc., not shown). In the illustrated implementation, upstream port 140 is a USB port.

Autorun firmware 130 causes an application or executable stored in memory component 110 to be installed or run automatically upon activation of the IC memory device 100 vis-à-vis the host computing device 150. This activation may be achieved in a variety of ways including connecting or inserting the autorun IC memory device 100 into a docking system or port present on or interfaced to the host computing device 150. For example, IC memory device 100 with autorun firmware 130 incorporated into USB microcontroller 120 allows a “USB Flash Drive” storing one or more application executables or installables to be run automatically (i.e., autorun) upon activation, such as being plugged into the USB port of a host PC 150.

FIG. 2 is a block diagram of a prior art arrangement in which a host personal computer 200 includes an intermediate hardware dock 220 that provides an autorun feature for a storage medium like a CD-ROM 230. Intermediate hardware dock 220 functions as a storage media reader that may be internally integrated with or externally connected to the host personal computer 200 and the storage medium 230.

In this prior art implementation, insertion of a CD-ROM disc 230 into a CD-ROM dock/reader 220 may cause activation of an autorun feature that is stored on or incorporated into CD-ROM dock/reader 220. Executables or installers stored on the CD-ROM disc 230 may then be executed by the host personal computer 200 based upon activation by the autorun feature CD-ROM dock/reader 220.

As another example of such a prior art implementation, a flash memory card reader connected to a host computing device, such as a personal computer, may also include an autorun feature that can activate an executable or installer to run on the host computing device.

A disadvantage of such prior art implementations is that autorun features are incorporated into hardware docks or readers that are separate from the storage media. However, the popular and widely-adopted Universal Serial Bus technology does not include such distinct autorun features. As a consequence, conventional integrated circuit memory devices such as USB memory devices do not have autorun functionality. In contrast, the present invention provides autorun functionality to any IC memory device, such as any USB peripheral that has a memory component interfaced to a USB microcontroller.

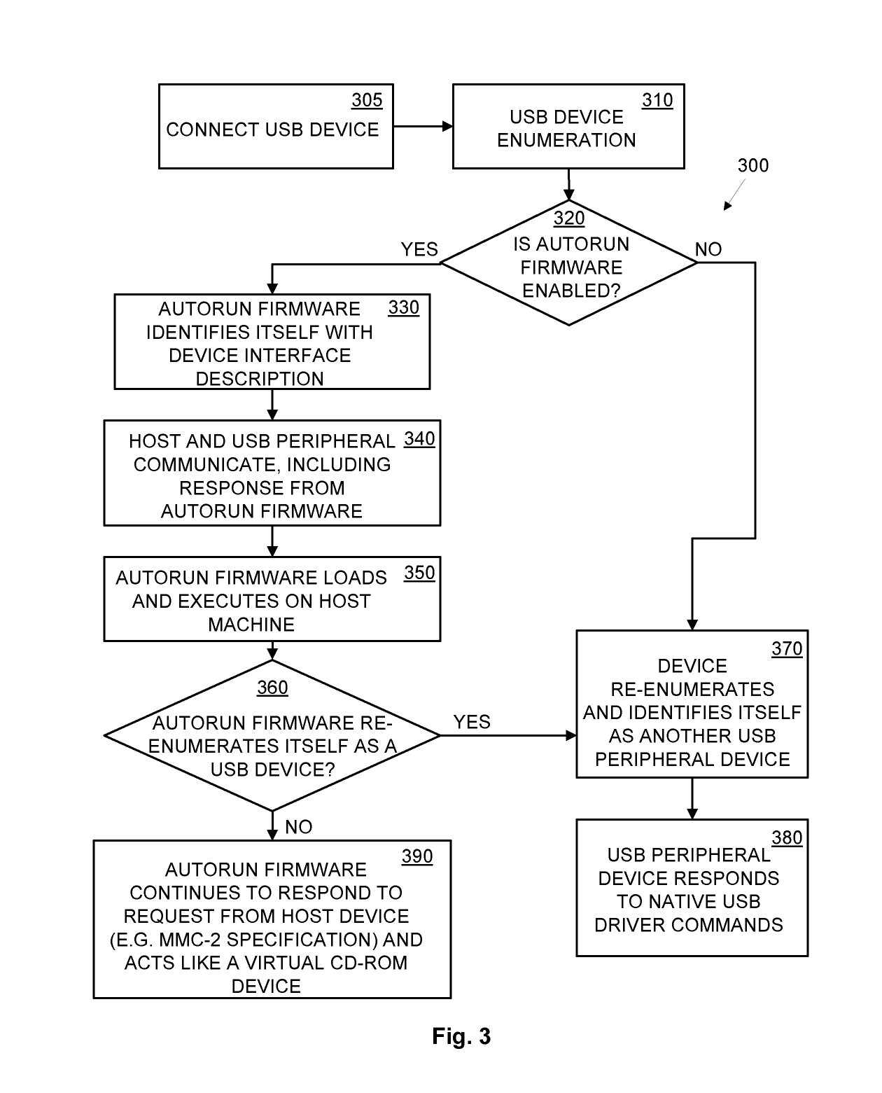

FIG. 3 is a flow diagram of an IC memory device autorun method 300 that may be implemented from firmware 130 incorporated into a USB controller 120.

In step 305, a USB peripheral is inserted into or connected to a USB port of a host computing device (e.g., a personal computer).

In step 310, the host computing device performs an enumeration to identify the newly attached USB peripheral.

Step 320 is a query as to whether the USB peripheral includes autorun firmware that is enabled. If so, step 320 proceeds to step 330. If not, step 320 proceeds to step 370.

In step 330, the autorun firmware in the USB peripheral announces itself with a device interface description. For example, the device interface description may include Mass Storage Class, SCSI transparent command set, Bulk Only Transport corresponding to a CD-ROM, for example.

In step 340, the host and the USB peripheral communicate with each other using, for example a standard MMC-2 specification set. The communication includes a response to host commands from the autorun firmware according to the MMC-2 specification. As a part of the MMC-2 specification, the host requests enumeration of files in root directory and the autorun firmware responds to the request.

In step 350, the autorun firmware informs the host of the presence of an autorun executable file to be executed and provides the file to the host. For example, the file may be named “Autorun.inf,” which may be stored on the memory component of the USB peripheral. The host executes the autorun executable file to provide the autorun functionality.

Step 360 is a query whether the autorun firmware is to be enumerated again or “re-enumerated.” If so, step 360 proceeds to step 370. If not, step 360 proceeds to step 390. Re-enumeration allows the autorun firmware to announce itself to the host as one or more other USB peripherals (e.g. data storage device, communication adapter, etc.) or, if there is no re-enumeration, the autorun firmware can continue to function as per MMC-2 specifications.

In step 370, the autorun firmware re-enumerates or identifies itself as another USB device, such as a USB flash drive or a USB wireless (e.g., Bluetooth, WiFi, IrDA) device or “dongle.” With such a re-enumeration, the autorun firmware identifies itself with device interface descriptors for the other USB devices (e.g., USB flash drive or USB Bluetooth dongle).

In step 380, the autorun firmware loads the firmware associated with the enumerated USB peripheral (e.g., USB flash drive or USB Bluetooth dongle).

In step 390, the autorun firmware is configured to not re-enumerate itself and continues to act as a virtual CD-ROM type device implementing the MMC-2 specifications.

Process steps 320, 330, 340, 350 and 360 correspond to the autorun firmware implementation. Step 390 provides for the implementation of a virtual mass storage device from a memory component that implements SCSI command set and MMC-2 specifications.

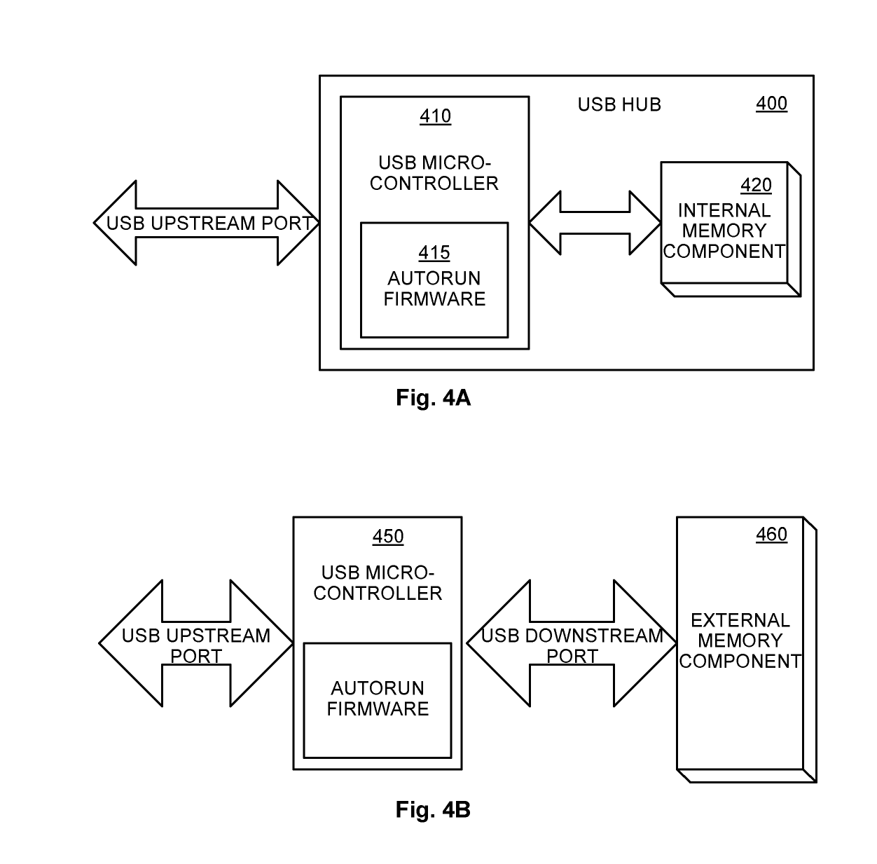

Autorun firmware according to the present invention can be embedded into multiple USB device configurations to provide a variety of unique USB peripherals with autorun functionality and into other peripheral devices with similar functionality. For example, FIG. 4A shows a USB hub 400 in which a USB microcontroller 410 with auto run firmware 415 communicates with an internal memory component 420. In FIG. 4B, a USB microcontroller 450 is connected to an external memory component 460 through a USB downstream port 470.

With reference to FIG. 4A, the USB microcontroller 410 that forms a part of the USB hub 400 typically is a repeater type entity allowing for cascaded multiple USB peripherals to connect through a single upstream port to a host system. The USB microcontroller 410 includes support for programming capability, which includes the autorun firmware 415. The Autorun firmware can then be ported to work on the USB microcontroller 410. The firmware may be stored on the internal memory component 420. Alternatively, the Autorun firmware may be stored on external memory that is in an attached USB memory component 430.

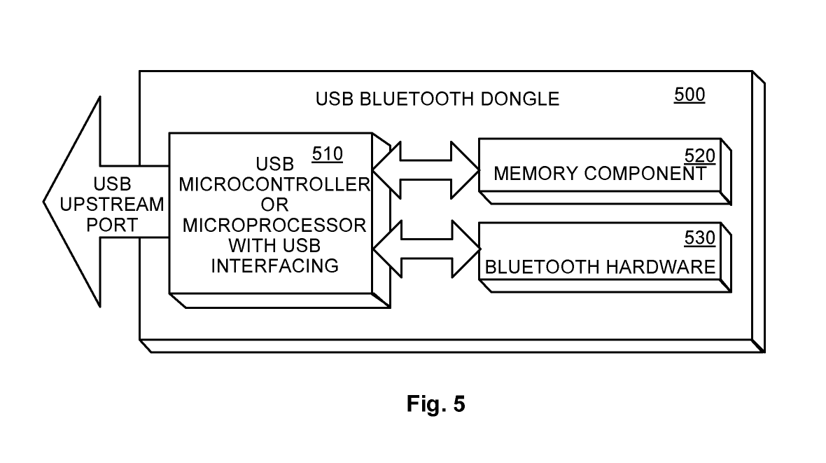

As another configuration, FIG. 5 is a block diagram of a USB peripheral 500 having multiple functionalities. In this implementation, USB peripheral 500 includes an internal microprocessor with USB interfacing 510, or alternatively a USB microcontroller, that communicates with a memory component 520 and wireless (e.g., Bluetooth) networking hardware 530. As a result, USB peripheral 500 is capable of operating as a wireless (e.g., Bluetooth) networking device or “dongle” and as USB flash drive, both of which are accessible with autorun functionality

In one configuration, the microprocessor 510 has USB interfacing ability. It is coupled with a memory component 520 and Bluetooth radio component 530. Microprocessor 510 implements client layers of the Bluetooth stack. The firmware that the microprocessor 510 executes is stored in memory component 520. The autorun firmware can also be additionally stored as a part of the functionality of existing firmware or separately in the memory component 520. In another configuration, the microprocessor 510 may not directly have USB interfacing capability and could use a separate USB microcontroller (not shown).

A feature of including autorun firmware in USB peripherals is that software applications can be bundled with the USB peripherals. The bundled software application may or may not utilize the USB peripheral.

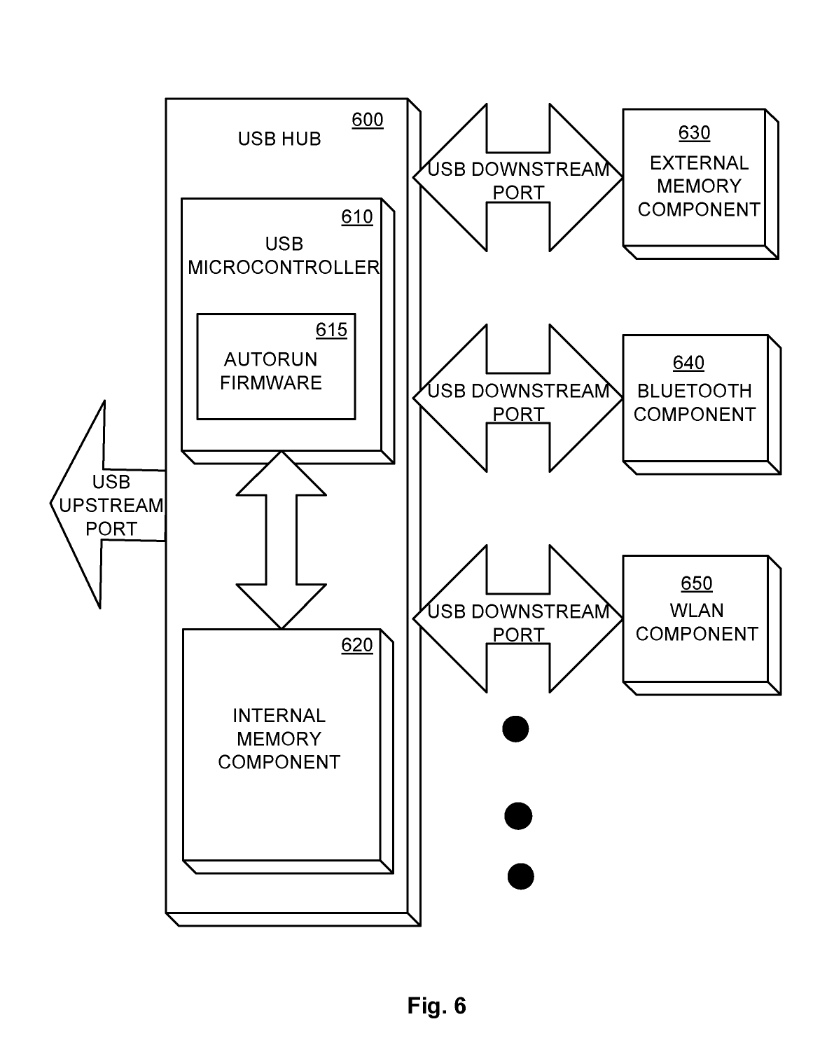

As an example, FIG. 6 is a block diagram of a USB hub 600 that includes a USB microcontroller 610 with autorun firmware 615 and access to one or multiple distinct functionalities or USB peripherals, such as an external memory component 630, a Bluetooth networking component 640, or a WLAN component 650. Such USB peripherals 630-650 could be formed in combination with USB hub 600. USB hub 600 may be externally connected with one or more of these components 630-650, as illustrated, or alternatively one or more of the components 630-650 can be internally integrated to form a USB peripheral or device with multiple distinct functionalities.

There could be multiple executions of autorun firmware from each or some of these peripherals. Thus the autorun firmware allows for distribution of software (e.g. device drivers, synchronization software, etc.) that can be autorun along with any USB peripheral.

The implementation options also include mechanisms for allowing the autorun feature to be enabled or disabled by an external mechanism (e.g., switch) that is included on the device or peripheral. The switch could be manually operable by a person. The switch could be a simple two-mode (e.g., autorun on/off) switch or could be a switch that selects from among more than two modes.

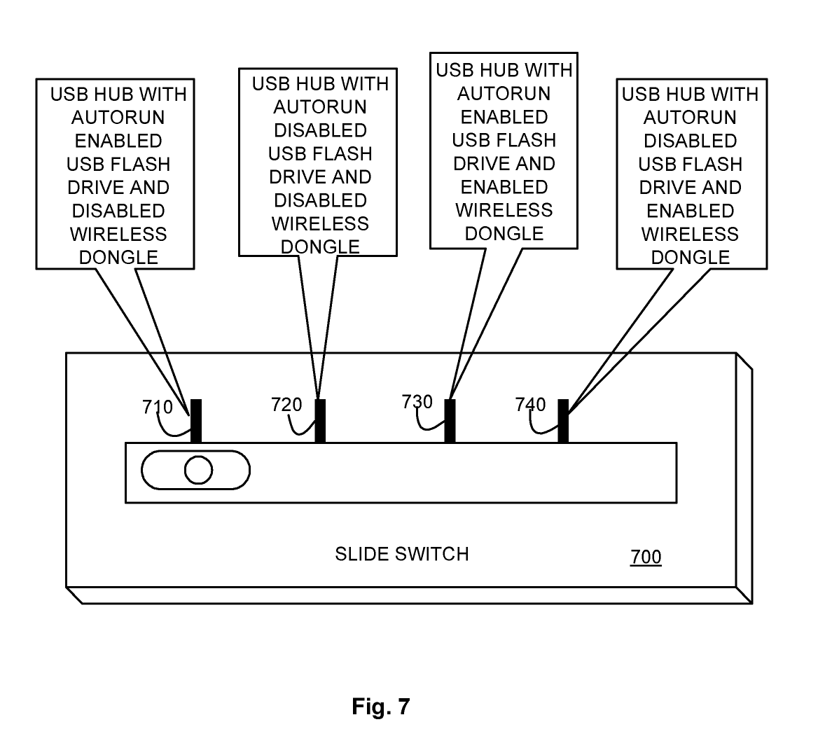

FIG. 7 is a schematic diagram of a person-operable physical slide switch 700 that allows a person to select from among multiple modes, functionalities, or peripherals available on a USB device or “dongle.” As an example, switch 700 relates to features or peripherals available from USB hub 600 of FIG. 6, including external memory component 630, and wireless dongle or module (640 or 650) for adding wireless (e.g. Bluetooth, WiFi, IrDA) interface to its host PC.

In this exemplary illustration, switch 700 has 4 user-selectable positions. In position 710, autorun functionality is enabled, the wireless component is disabled. In position 720, autorun functionality is disabled, wireless component is disabled. In position 730, autorun functionality is enabled, wireless component is enabled. In position 740, autorun functionality is disabled, wireless component is enabled.

The autorun firmware enables the distribution of software that can be autorun from a memory component. There is also a unique security mechanism that can be incorporated to protect the software that is installable or executable from the memory component by the autorun firmware.

A section of the internal memory component (e.g., memory component 620, FIG. 6) may be protected from public access by password protecting it or by physical security means such as a lock, among other means. The flash memory component can also be segmented into public and private sections. Private sections can be used to store installable or executables that cannot be viewed or accessed by the user, and public sections can be viewed or accessed by users in a conventional manner. The installable or executable software being distributed through the memory component can be stored in the protected region of the memory component. Security by way of copy protection of this installable software can be achieved by allowing only an application launcher executable, which is autorun from the memory component, to access the installable software.

In one implementation, the application launcher executable has the following characteristics: it is autorun from memory component, and it has access to the protected or private region of memory component. This access is gained by authenticating itself to the memory controller (e.g. USB microcontroller) and/or to the installable software in the protected region of the memory component. The authentication mechanism may be a password-based mechanism or a more involved cryptographic algorithm. Among the various techniques used for authentication are digital signatures and unique identifiers like the Bluetooth Device Address, MAC address, etc. The application launcher executable may authenticate itself directly to the memory controller software and/or installable software or to a separate authentication software that resides in the protected region of the memory component.

The application launcher executable may be built generically to execute any or all executables and installables that exist within the protected region of the memory component. Alternatively, the application launcher executable may be programmed to launch a particular executable or installable from the protected region. Considering the possibility of the memory component being segmented into “n” protected sections where n is greater than 1, the application launcher executable may access one or more of these sections in the mechanism described herein. The protected memory region may contain, for example, executable software (also called an application executable), or installable software (also called an application installable), or protected data.

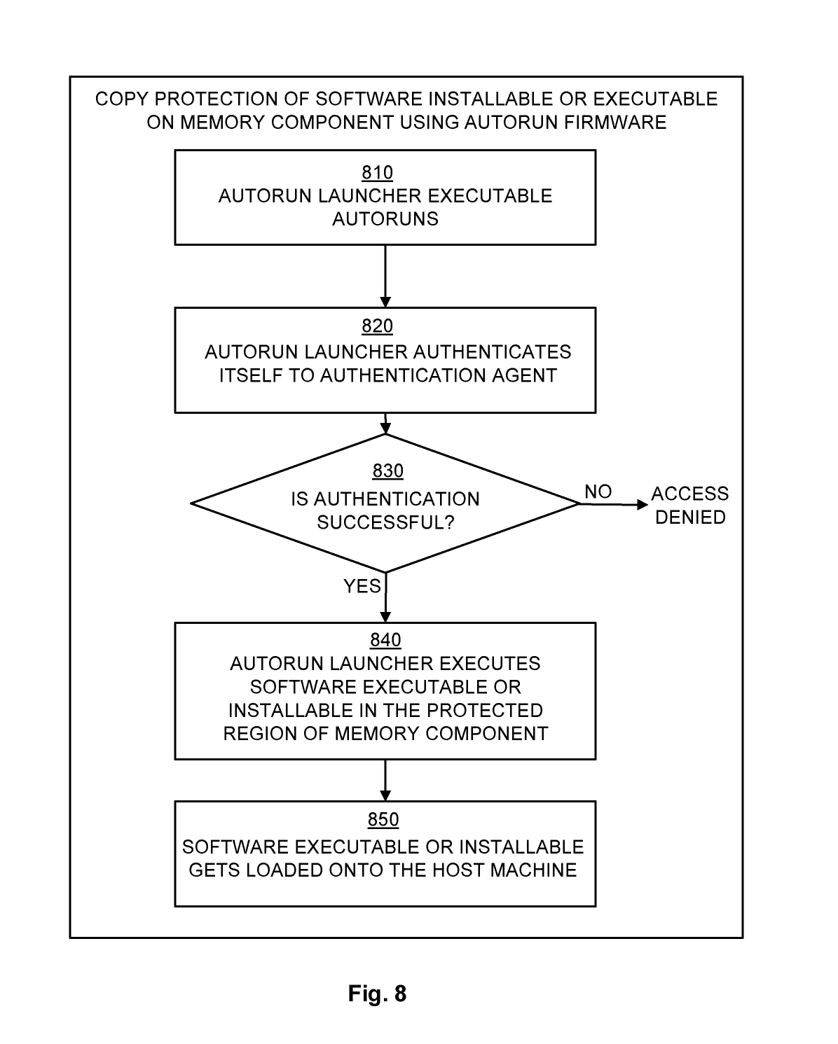

FIG. 8 is a flow diagram of a software-implemented copy protection method for protecting of software that is executable or installable on using autorun firmware.

In step 810, an application launcher executable that is stored in a memory component of an IC memory device is run automatically on a host computer by an autorun firmware stored on the IC memory device. The autorun firmware is operates automatically upon activation of the IC memory device, such as occurs when the memory device is plugged into a port or socket of the host computer.

In step 820, the application launcher authenticates itself to authentication agent software that resides in the protected region of the memory component. The authentication agent software may be incorporated within the software executable or installable that is being protected or may be a separate application. The authentication algorithm may be password based or may involve cryptographic techniques.

Step 830 is a query whether the authentication is successful. If not, access to the protected executable or installable is denied. If authentication is successful, step 830 proceeds to step 840 and the application launcher executable gains access to the protected memory region.

In step 840, the application launcher executable executes the application executable or installable that is stored in the protected region of the memory component. The application launcher executable may also be programmed to execute any or all executables and installables that exist within the protected region of the memory component.

In step 850, the executables and installables thus launched are executed on the host computer.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A mobile information apparatus operable for making mobile payments by short range point-to-point wireless communication with a wireless controller device that is within a limited physical distance, the wireless output controller being a distinct device from the mobile information apparatus, the mobile information apparatus comprising:
a processing unit;
operating system software;
a touch sensitive screen interface for interacting with the user;
a digital camera for taking pictures;
an antenna for transmitting short range radio frequency signals to wireless controller devices that are within a limited physical distance from the mobile information apparatus;
a wireless communication unit for managing local wireless communication with wireless controller devices that are within a limited physical distance from the mobile information apparatus;
a memory controller;
a memory component;
a protected memory area in the memory component storing protected data that is implemented to be not accessible by a user of the integrated circuit memory device, but is implemented to be accessible by the memory controller implementing, at least in part, a cryptographic algorithm, the protected data stored in the protected memory area of the mobile information apparatus includes at least part of payment information, and the payment information being associated, at least in part, with a credit card or a bank card related to the user of the mobile information apparatus;
wherein the mobile information apparatus is configured for:
establishing, by the wireless communication unit over the antenna, a short range point-to-point radio frequency communication link directly between the mobile information apparatus and the wireless output controller, the establishing of the short range point-to-point radio frequency communication link being when the mobile information apparatus is within a limited local physical distance from the wireless output controller;
accessing, by the memory controller, the protected data that includes at least part of payment information stored in the protected memory area;
implementing, at least in part by the memory controller, a cryptographic algorithm for accessing the protected data stored in the protected memory area;
generating, at the mobile information apparatus, encrypted output data for ensuring security of communication from the mobile information apparatus to the wireless output controller for transaction management, the encrypted output data is associated with the payment information stored at the memory or storage unit of the mobile information apparatus, and the payment information is associated, at least partly, with a credit card;
receiving at least an indication from the user of the mobile information apparatus for releasing payment information from the mobile information apparatus to the wireless output controller, the indication from the user includes an authentication procedure using at least one of a password, a PIN code, or biometrics, individually or in any combination, from the user; and
subsequent to the authentication procedure from the user at the mobile information apparatus, the mobile information apparatus is operable for wireless transmitting at least part of the encrypted output data, over the short range point-to-point radio frequency communication link directly from the mobile information apparatus to the wireless output controller for processing payment associated with a transaction.

2. The apparatus of claim 1 in which the security of the mobile payment is implemented with all of the following techniques:
(1) a physical distance restriction directly between the mobile information apparatus and the wireless output controller;
(2) a protected memory component storing a secure element or protected data;
(3) access of protected data or secure element by a controller implementing a cryptographic algorithm;
(4) an encryption technique applied on data being transmitted from the mobile information apparatus to the wireless output controller; and
(5) at least one of user biometrics authentication or user password authentication.

3. The apparatus of claim 1, wherein the mobile information apparatus is further configured for automatically obtaining, at the mobile information apparatus, a device number or device identification associated with the mobile information apparatus as an authentication procedure for authorizing release of payment information to the wireless output controller.

4. The apparatus of claim 1, wherein the mobile information apparatus is further configured for instructing the user of the mobile information apparatus to physically point the mobile information apparatus directly to the wireless output controller to be within a limited physical distance for establishing a short range radio frequency communication link directly between the mobile information apparatus and the wireless output controller.

5. The apparatus of claim 1 in which the mobile information apparatus is a smart phone that includes:
a touch sensitive screen interface for interacting with the user;
a graphical user interface over the touch sensitive screen;
a digital camera for taking pictures; and
one or more applications installed, wherein the operating system software further supports an application programming interface (API) to facilitate operations of the one or more applications at the mobile information apparatus, and the smart phone further allows the user to install additional applications for expanding the functionalities of the smart phone.

6. The apparatus of claim 1, wherein the mobile information apparatus is further configured for obtaining, at the mobile information apparatus, fingerprint information associated with the user.

7. A method for mobile payment operable with a mobile information apparatus, the mobile information apparatus having:
a processing unit,
operating system software that is executable, at least partly, by the processing unit of the mobile information apparatus,
a touch sensitive screen interface for interacting with the user,
a digital camera for taking pictures,
an antenna for transmitting short range radio frequency signals for wireless communication with wireless controller devices that are within a limited physical distance from the mobile information apparatus,
a wireless communication unit for managing local wireless communication with a wireless controller device that is within a limited physical distance from the mobile information apparatus,
a memory controller,
a memory component,
a protected memory area in the memory component storing protected data that is implemented to be not accessible by a user of the integrated circuit memory device, but is implemented to be accessible by the memory controller implementing, at least in part, a cryptographic algorithm,
the method comprising:
storing protected data in the protected memory area of the mobile information apparatus, the protected data stored in the mobile information apparatus being associated with at least part of payment information, and the payment information being associated, at least in part, with a credit card or a bank card related to the user of the mobile information apparatus;
establishing, by the wireless communication unit and over the antenna, a short range point-to-point radio frequency communication link between the mobile information apparatus and a wireless output controller, the wireless output controller being a distinct and separate device from the mobile information apparatus, and the establishing of the short range point-to-point radio frequency communication link is limited to when the mobile information apparatus is within a limited physical distance from the wireless output controller;
accessing, by the memory controller, the protected data that includes at least part of payment information stored in the protected memory area, the access of the protected data from the protected memory area includes implementing a cryptographic algorithm;
generating, at the mobile information apparatus, encrypted output data for ensuring security of communication from the mobile information apparatus to the wireless output controller, the encrypted output data is associated with the payment information, and the payment information is associated, at least partly, with a credit card or a bank card;
receiving at least an indication from the user of the mobile information apparatus for releasing payment information from the mobile information apparatus to the wireless output controller, the indication from the user includes biometric authentication; and
subsequent to receiving the biometric authentication from the user at the mobile information apparatus, wireless transmitting at least part of the encrypted output data, over the short range point-to-point radio frequency communication link directly from the mobile information apparatus, to the wireless output controller for processing payment associated with a transaction.

8. The method of claim 7 in which the security of the mobile payment method relies, at least in part, on all of the following:
(1) a physical distance restriction directly between the mobile information apparatus and the wireless output controller;
(2) a protected memory component storing a secure element or protected data;
(3) access of protected data or secure element by a controller implementing a cryptographic algorithm;
(4) an encryption technique applied on data being transmitted from the mobile information apparatus to the wireless output controller; and
(5) user biometric authentication.

9. The method of claim 7, further comprising implementing an authentication procedure that includes a device number or device identification associated with the mobile information apparatus.

10. The method of claim 7, further comprising instructing the user of the mobile information apparatus to physically point the mobile information apparatus directly to a wireless output controller to be within the limited physical distance for establishing the short range point-to-point radio frequency communication link.

11. The method of claim 7, further comprising discovering the wireless output controller device when the mobile information apparatus is within the limited physical distance directly between the mobile information apparatus and the wireless output controller.

12. The method of claim 7 further comprising, after the wireless output controller receives output data from the mobile information apparatus, the wireless output controller implementing a payment service and a transaction management service, and the user being charged a fee for using the payment service or the transaction management service.

13. The method of claim 7, further comprising obtaining a signature from the user of the mobile information apparatus for authorizing payment.

14. A mobile information apparatus system for mobile payment, the system comprising:
a processing unit;
software executable by the processing unit for obtaining, at the mobile information apparatus system, at least one of biometric authentication, password authentication, or PIN code authentication, individually or in any combination, from the user of the mobile information apparatus for authorizing mobile payment;
a touch sensitive screen interface for interacting with the user;
a memory controller;
a memory component;
a protected memory area in the memory component storing protected data that is implemented to be not accessible by a user of the integrated circuit memory device, but is implemented to be accessible by the memory controller implementing, at least in part, a cryptographic algorithm, the protected data stored in the protected memory area of the mobile information apparatus includes at least part of payment information, and the payment information being associated, at least in part, with a credit card or a bank card related to the user of the mobile information apparatus;
an antenna for transmitting short range radio frequency signals; and
a wireless communication unit for establishing short range point-to-point radio frequency communication, and wherein subsequent to having received the obtained authentication from the user authorizing payment, the wireless communication unit is configured for:
managing local wireless communication with a wireless output controller that is within a limited physical distance from the mobile information apparatus;
establishing, a short range radio frequency communication link directly between the mobile information apparatus and a wireless output controller, the wireless output controller being a distinct and separate device from the mobile information apparatus, and the establishing of the short range radio frequency communication link is limited to when the mobile information apparatus is within a limited physical distance from the wireless output controller;
obtaining payment information that is stored in the protected memory area of the mobile information apparatus, the payment information is associated, at least partly, with a credit card or a bank card, and the obtaining of the payment information is facilitated, at least in part, by the memory controller;
encrypting data for communication, the encryption for ensuring security of communication from the mobile information apparatus to the wireless output controller; and
transmitting the payment information that includes encrypted data, over the short range point-to-point radio frequency communication link directly from the mobile information apparatus to the wireless output controller for processing payment.

15. The system of claim 14 in which the security of the mobile payment relies, at least in part, on all of the following:
(1) a physical distance restriction directly between the mobile information apparatus and the wireless output controller;
(2) a protected memory component storing a secure element or protected data;
(3) access of protected data or secure element by the memory controller implementing a cryptographic algorithm;
(4) an encryption technique applied on data being transmitted from the mobile information apparatus to the wireless output controller; and
(5) biometric authentication, or password authentication, or PIN code authentication.

16. The system of claim 14, wherein the wireless communication unit is further configured for transmitting the payment information that includes encrypted data to the wireless output controller for processing payment through a payment service of the wireless output controller, the user of the mobile information apparatus being charged a fee for the payment service.

17. The system of claim 14, wherein the wireless communication unit is further configured for instructing the user of the mobile information apparatus to physically point the mobile information apparatus directly to a wireless output controller to be within the limited physical distance for establishing the short range radio frequency communication link.

18. The system of claim 14, wherein the encryption of data is implemented by both software and hardware as a security implementation.

19. The system of claim 14, wherein the wireless communication unit is further configured for obtaining, at the mobile information apparatus, a fingerprint from the user for authorizing payment.

20. The system of claim 14 in which the mobile information apparatus is a smart phone that includes:
a touch sensitive screen interface for interacting with the user;
a graphical user interface over the touch sensitive screen;
a digital camera for taking pictures;
one or more applications installed; and
an operating system that supports an application programming interface (API) to facilitate operations of the one or more applications at the mobile information apparatus, wherein the smart phone further allows the user to install additional applications for expanding the functionalities of the smart phone.
